(19) United States
(12) Patent Application Publication
(10) Pub. No.: US 2024/0278231 A1
(43) Pub. Date: Aug. 22, 2024

(54) METHOD AND APPARATUS FOR ACQUIRING INFORMATION ON BIOMATERIALS THROUGH A BIOSENSOR INCLUDING A META-OPTICAL ELEMENT

(71) Applicant: ELECTRONICS AND TELECOMMUNICATIONS RESEARCH INSTITUTE, Daejeon (KR)

(72) Inventor: Jin Tae KIM, Daejeon (KR)

(21) Appl. No.: 18/428,915

(22) Filed: Jan. 31, 2024

(30) Foreign Application Priority Data
Feb. 16, 2023 (KR) 10-2023-0020638

(51) Int. Cl. B01L 3/00; G06T 7/00

(52) U.S. Cl. CPC B01L 3/5023; G06T 7/0012; B01L 2200/025; B01L 2300/048; B01L 2300/0636; B01L 2400/049; G06T 2207/30024

(57) ABSTRACT

A method performed by a biosystem comprising a biosensor kit and a biosensor kit analyzer is disclosed. According to an embodiment of the present disclosure, a method performed by a biosystem may include injecting a solution sample into the biosensor kit, the biosensor kit including a biosensor equipped with at least one metasurface element, based on the biosensor kit being inserted into the biosensor kit analyzer, injecting incident light into a lower region of the at least one metasurface element by the biosensor kit analyzer; obtaining a pattern image of output light changed by the at least one meta-surface element; obtaining, by the biosensor kit analyzer, a presence or absence and amount of biomaterial on the solution sample by inputting the pattern image into a pre-trained artificial intelligence model; and displaying the presence or absence and amount of the biomaterial on the solution sample.

### CROSS-REFERENCE TO RELATED APPLICATIONS

This application claims the benefit of earlier filing date and right of priority to Korean Application No. 10-2023-0020638, filed on Feb. 16, 2023, the contents of which are all hereby incorporated by reference herein in their entirety.

### TECHNICAL FIELD

The present disclosure relates to the field of obtaining information on biomaterials, and more specifically, to a method and device for acquiring information on biomaterials through a biosensor including a meta-optical element.

### BACKGROUND

Methods for more efficiently diagnosing and detecting biomaterials contained in solution samples are continuously being researched, and various disease diagnostic kits developed based on this are widely used.

Previously, antigen-antibody immunoassays were developed and used for biosensing. Antigen antibody immunoassay is a method of performing biosensing through a sensor that changes color depending on the presence or absence of biomaterials. However, there was a problem that a precise optical spectrometer was needed to perform color discrimination in the antigen-antibody immunoassay.

Additionally, biosensing using surface plasmon resonance technology has previously been developed and utilized. That is, the surface plasmon resonance technique was applied to measure the optical signal of the immunoassay. However, in order to perform biosensing using surface plasmon resonance technology, there was a problem that a separate precision spectrum spectrometer was needed to measure the angle change of surface plasmon resonance.

### SUMMARY

The technical problem of the present disclosure is to provide a method and device for acquiring information about biomaterials through a biosensor including a meta-optical element.

The technical problem of the present disclosure is to provide a method and device for obtaining the presence or absence and amount of biomaterials by applying artificial intelligence calculation to the pattern of output light changed by a meta surface device.

The technical problems to be achieved in the present disclosure are not limited to the technical tasks mentioned above, and other technical problems not mentioned will be clearly understood by those skilled in the art from the description below.

In one embodiment of the present disclosure, a method performed by a bio system including a bio sensor kit and a bio sensor kit analyzer may include: injecting a solution sample into the biosensor kit through the solution sample inlet, the biosensor kit including a biosensor equipped with at least one metasurface element, based on the biosensor kit being inserted into the biosensor kit analyzer, injecting incident light into a lower region of the at least one metasurface element by the biosensor kit analyzer; obtaining a pattern image of output light changed by the at least one meta-surface element using the biosensor kit analyzer; obtaining, by the biosensor kit analyzer, a presence or absence and amount of biomaterial on the solution sample by inputting the pattern image into a pre-trained artificial intelligence model; and displaying the presence or absence and amount of the biomaterial on the solution sample by the biosensor kit analyzer.

In addition, the at least one meta surface element may include at least one of a first meta surface element and a second meta surface element, the first meta surface element may include a meta surface element that converts the incident light into a structured beam, and the second meta surface element may include a meta lens element that focuses the incident light to a specific point.

In addition, the structured beam may include a focused vortex beam.

In addition, the biosensor kit may include a biosensor seating portion on which the biosensor can be seated and an adhesive receiving structure capable of accommodating the adhesive added to the lower area of the biosensor.

In addition, the biosensor kit may absorb the solution sample injected through the solution sample inlet and includes a solution receptor, and a fluid channel through which the solution sample can flow may be formed between a cover of the biosensor kit and the solution receptor.

In addition, the biosensor kit may include an air outlet that absorbs or discharges air from the outside, and the biosensor kit analyzer may include an air intake structure connected to the air outlet, a vacuum pump hose connected to the air intake structure, and a vacuum pump connected to the vacuum pump hose.

In addition, the biosensor may be located in an area corresponding to a direction of the air intake structure with respect to the solution receptor within the biosensor kit, and based on the biosensor kit being inserted into the biosensor kit analyzer, air on the fluid channel may be discharged outside the biosensor kit through the air intake structure and the vacuum pump hose by the vacuum pump.

In addition, the biosensor kit may include a solution absorber that absorbs the solution sample that has passed through the biosensor, and the solution absorber may be located in an area corresponding to a direction of the air intake structure with respect to the biosensor within the biosensor kit.

In one embodiment of the present disclosure, a bio-system may include a biosensor kit comprising a biosensor equipped with at least one metasurface element; and a biosensor kit analyzer including at least one processor, light source, lens, image sensor, and display, based on a solution sample being injected through a solution sample inlet on the biosensor kit, the biosensor kit is inserted into the biosensor kit analyzer, the at least one processor may be configured to: inject incident light through the light source into a lower region of the at least one metasurface element; obtain a pattern image of output light changed by the at least one meta surface element through the lens and the image sensor; obtain, by the biosensor kit analyzer, a presence or absence and amount of biomaterial on the solution sample by inputting the pattern image into a pre-trained artificial intelligence model; and display the presence or absence and amount of the biomaterial on the solution sample on the display using the biosensor kit analyzer.

In one embodiment of the present disclosure, a method performed by a bio system including a biosensor kit, a biosensor kit analyzer, and a terminal device mounted on the biosensor kit analyzer may include injecting a solution sample into the biosensor kit through the solution sample inlet, the biosensor kit including a biosensor equipped with at least one metasurface element, based on the biosensor kit being inserted into the biosensor kit analyzer, injecting incident light into a lower region of the at least one metasurface element by the biosensor kit analyzer; obtaining a pattern image of output light changed by the at least one meta-surface element using the biosensor kit analyzer; obtaining, by the biosensor kit analyzer, a presence or absence and amount of biomaterial on the solution sample by inputting the pattern image into a pre-trained artificial intelligence model; and displaying the presence or absence and amount of the biomaterial on the solution sample by the biosensor kit analyzer.

In addition, the pattern image may be transmitted by the terminal device to a server including at least one parameter for executing the artificial intelligence model, and the presence or absence and amount of biomaterial on the solution sample based on the pattern image may be transmitted from the server to the terminal device.

The features briefly summarized above with respect to the disclosure are merely exemplary aspects of the detailed description of the disclosure that follows, and do not limit the scope of the disclosure.

According to various embodiments of the present disclosure, a method and device for acquiring information about a biomaterial through a biosensor including a meta-optical element may be provided.

According to various embodiments of the present disclosure, a method and device may be provided for effectively obtaining the presence or absence and amount of biomaterial by applying artificial intelligence calculation to the pattern of output light changed by a meta surface element.

According to various embodiments of the present disclosure, complex and large space-requiring optical components required when constructing an optical biosensor system may be replaced with cameras and artificial intelligence technology.

The effects obtainable in the present disclosure are not limited to the effects mentioned above, and other effects not mentioned will be clearly understood by those skilled in the art from the description below.

### BRIEF DESCRIPTION OF THE DRAWINGS

FIG. 1 is a flowchart illustrating a method of obtaining information about a biomaterial through a biosensor, according to an embodiment of the present disclosure.

FIG. 2 is a diagram for describing a biosystem according to an embodiment of the present disclosure.

FIGS. 3A, 3B, and 4 are diagrams for describing the structure of a biosensor kit according to an embodiment of the present disclosure.

FIG. 5 is a diagram illustrating the structure of a biosensor including a metasurface element according to an embodiment of the present disclosure.

FIG. 6A and FIG. 6B are diagrams for describing a pattern image of light output by a meta surface element according to an embodiment of the present disclosure.

FIG. 7 is a diagram for describing the structure of a biosensor kit analyzer according to an embodiment of the present disclosure.

FIG. 8 and FIG. 9 are conceptual diagrams of an artificial intelligence model that can be applied to an embodiment of the present disclosure.

FIG. 10A, FIG. 10B, and FIG. 10C are diagrams for describing the structure of a biosensor kit according to an embodiment of the present disclosure.

FIG. 11 is a diagram for describing the structure of a biosensor kit analyzer according to an embodiment of the present disclosure.

### DETAILED DESCRIPTION

Since the present disclosure can make various changes and have various embodiments, specific embodiments are illustrated in the drawings and described in detail in the detailed description. However, this is not intended to limit the present disclosure to specific embodiments, and should be understood to include all modifications, equivalents, and substitutes included in the idea and scope of the present disclosure. Similar reference numbers in the drawings indicate the same or similar function throughout the various aspects. The shapes and sizes of elements in the drawings may be exaggerated for clarity. Detailed description of exemplary embodiments to be described later refers to the accompanying drawings, which illustrate specific embodiments by way of example. These embodiments are described in sufficient detail to enable those skilled in the art to practice the embodiments. It should be understood that the various embodiments are different, but need not be mutually exclusive. For example, specific shapes, structures, and characteristics described herein may be implemented in another embodiment without departing from the idea and scope of the present disclosure in connection with one embodiment. Additionally, it should be understood that the location or arrangement of individual components within each disclosed embodiment may be changed without departing from the spirit and scope of the embodiment. Accordingly, the detailed description set forth below is not to be taken in a limiting sense, and the scope of the exemplary embodiments, if properly described, is limited only by the appended claims, along with all equivalents as claimed by those claims.

In this disclosure, terms such as first and second may be used to describe various components, but the components should not be limited by the terms. These terms are only used for the purpose of distinguishing one component from another. For example, a first element may be termed a second element, and similarly, a second element may be termed a first element, without departing from the scope of the present disclosure. The term and/or includes a combination of a plurality of related recited items or any one of a plurality of related recited items.

When an element of the present disclosure is referred to as being “connected” or “connected” to another element, it may be directly connected or connected to the other element, but it should be understood that other components may exist in the middle. On the other hand, when an element is referred to as “directly connected” or “directly connected” to another element, it should be understood that no other element exists in the middle.

Components appearing in the embodiments of the present disclosure are shown independently to represent different characteristic functions, and do not mean that each component is composed of separate hardware or a single software component. That is, each component is listed and included as each component for convenience of description, and at least two components of each component are combined to form one component, or one component can be divided into a plurality of components to perform functions. An integrated embodiment and a separate embodiment of each of these components are also included in the scope of the present disclosure unless departing from the essence of the present disclosure.

Terms used in the present disclosure are only used to describe specific embodiments, and are not intended to limit the present disclosure. Singular expressions include plural expressions unless the context clearly dictates otherwise. In the present disclosure, terms such as “comprise” or “have” are intended to designate that there are features, numbers, steps, operations, components, parts, or combinations thereof described in the specification, and it should be understood that this does not preclude the possibility of the presence or addition of one or more other features, numbers, steps, operations, components, parts, or combinations thereof. That is, the description of “including” a specific configuration in the present disclosure does not exclude configurations other than the corresponding configuration, and means that additional configurations may be included in the practice of the present disclosure or the scope of the technical spirit of the present disclosure.

Some of the components of the present disclosure may be optional components for improving performance rather than essential components that perform essential functions in the present disclosure. The present disclosure may be implemented including only components essential to implement the essence of the present disclosure, excluding components used for performance improvement, and a structure including only essential components excluding optional components used only for performance improvement is also included in the scope of the present disclosure.

Hereinafter, embodiments of the present disclosure will be described in detail with reference to the drawings. In describing the embodiments of this specification, if it is determined that a detailed description of a related known configuration or function may obscure the gist of the present specification, the detailed description will be omitted. The same reference numerals are used for the same components in the drawings, and redundant descriptions of the same components are omitted.

Hereinafter, a biosensor system based on camera and artificial intelligence (AI) technology that can replace optical components that require a large space will be described.

Here, the biosensor system may be composed of a biosensor kit including a biosensor and a biosensor kit analyzer. The biosensor may include one or more meta-surface elements (and/or meta-optical elements).

Here, the meta-surface device refers to an optical device in which an array of sub-wavelength nanostructures smaller than a normal wavelength are regularly arranged according to design. In other words, a metasurface device may refer to an ultra-thin planar optical device that can modulate the amplitude, phase, and polarization of incident light.

The method of acquiring information on biomaterials based on the biosensor system and the configuration of the biosensor will be described with reference to the drawings described later.

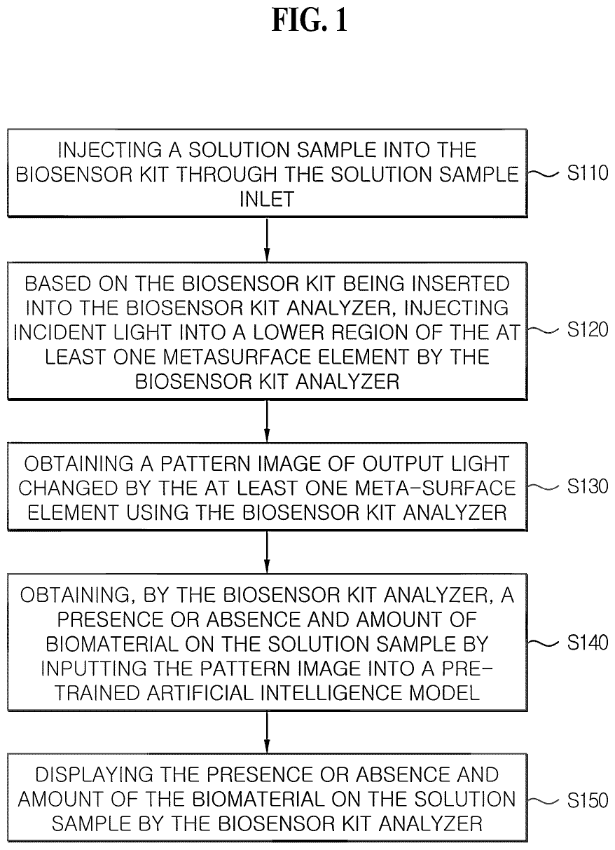

FIG. 1 is a flowchart illustrating a method of obtaining information about biomaterials through a biosensor including a meta-optical/surface device, according to an embodiment of the present disclosure.

A solution sample may be injected into the biosensor kit through the solution sample inlet (S110).

One or more metasurface elements may be mounted on the biosensor. As an example, the one or more meta surface elements may include at least one of a first meta surface element and a second meta surface element.

For example, the first meta surface element may include a meta surface element that converts incident light into a structured beam. A structured beam refers to a beam that has a specific structure/pattern. That is, the first meta surface element may convert a beam incident in various forms, such as radial, into a beam with a specific structure/pattern. For example, the structured beam may include a focused vortex beam that forms a donut shape.

The second meta surface element may include a meta lens element that focuses incident light to a specific point.

The biosensor kit may include a biosensor seating portion on which the biosensor may be seated and an adhesive receiving structure capable of accommodating the adhesive added to the bottom area (or bottom area) of the biosensor. The adhesive receiving structure may include one or more protrusions (e.g., trapezoid-shaped protrusions, etc.).

Accordingly, when the biosensor is seated on the biosensor seating portion, the adhesive prepared on the bottom area of the biosensor may be distributed in the empty space between the protrusions.

Additionally, the biosensor kit may absorb the solution sample injected through the solution sample inlet and include a solution receptor. A fluid channel through which the solution sample may flow may be formed between the cover of the biosensor kit and the solution receptor. Accordingly, the solution sample injected through the solution sample inlet may flow toward the biosensor through the fluid channel.

In one embodiment of the present disclosure, the biosensor kit may include an air outlet that absorbs or discharges air from the outside. That is, air within the fluid channel within the biosensor kit may be circulated through the air outlet.

The biosensor kit analyzer may include an air intake structure connected to the air outlet, a vacuum pump hose connected to the air intake structure, and a vacuum pump connected to the vacuum pump hose. That is, when the vacuum pump operates, air on the fluid channel may be discharged to the outside of the biosensor kit through the vacuum pump hose and air intake structure. Accordingly, a vacuum state may be induced within the fluid channel.

The biosensor may be located in an area corresponding to the direction of the air intake structure with respect to the solution receptor within the biosensor kit. Accordingly, when the air on the fluid channel is discharged to the outside of the biosensor kit through the vacuum pump hose, the solution sample absorbed in the solution receptor may be induced to flow in the direction of the biosensor.

Additionally, the biosensor kit may include a solution absorber that absorbs the solution sample that has passed through the biosensor. The solution absorber may be located in an area corresponding to the direction of the air intake structure with respect to the biosensor within the biosensor kit. That is, the solution sample that has passed through the biosensor may be guided to flow in the direction of the solution absorber, and the solution sample may be absorbed on the solution absorber.

Based on the biosensor kit being inserted into the biosensor kit analyzer, the biosensor kit analyzer may inject incident light into the lower area (or region) of one or more metasurface elements (S120).

That is, the biosensor kit may inject incident light through a light source (e.g., light emitting diode (LED), laser, etc.) into the lower area of the meta surface element.

The biosensor kit analyzer may acquire a pattern image of output light changed by one or more meta surface elements (S130).

That is, the biosensor kit analyzer may acquire a pattern image of output light changed by one or more metasurface elements through a lens and an image sensor. At this time, a pattern image of output light may be obtained for each metasurface element. That is, the biosensor kit analyzer may acquire a pattern image of the first output light changed by the first meta surface element and a pattern image of the second output light changed by the second meta surface element.

The biosensor kit analyzer may obtain the presence or absence and amount of biomaterials on the solution sample by inputting the pattern image into a pre-trained AI model by the biosensor kit analyzer (S140).

At this time, the AI model may be learned/trained based on the pattern image dataset of output light and the presence or absence and amount of biomaterials labeled in the image dataset. The AI model may consist of one or more convolution layers and a pooling layer, but is not limited thereto.

The biosensor kit analyzer may transmit a pattern image of the output light to a server including one or more parameters for running an AI model. The biosensor kit analyzer may receive the pattern image learning results of the output light based on the AI model from the server.

In other words, the biosensor kit analyzer may utilize a built-in AI model or an AI model provided on the server.

The biosensor kit may display the presence or absence and amount of the biomaterial on the solution sample (S150).

That is, the biosensor kit may display the pattern image of output light and/or the presence or absence and amount of biomaterials on the solution sample through the display.

As another example of the present disclosure, a terminal device (e.g., smartphone, tablet PC, etc.) may be mounted on the biosensor kit analyzer. In other words, the terminal device may replace the display, computing device, camera, etc. of the biosensor kit.

For example, S130 may be replaced with a step of acquiring a pattern image of output light changed by one or more meta surface elements by the terminal device.

S140 may be replaced with a step of obtaining the presence or absence and amount (or number) of biomaterials on the solution sample by inputting the pattern image into a pre-trained AI model by the terminal device.

S150 may be replaced with a step of displaying the presence or absence and amount of the biomaterial on the solution sample by the terminal device.

Here, the terminal device may utilize a built-in AI model or an AI model provided in the server.

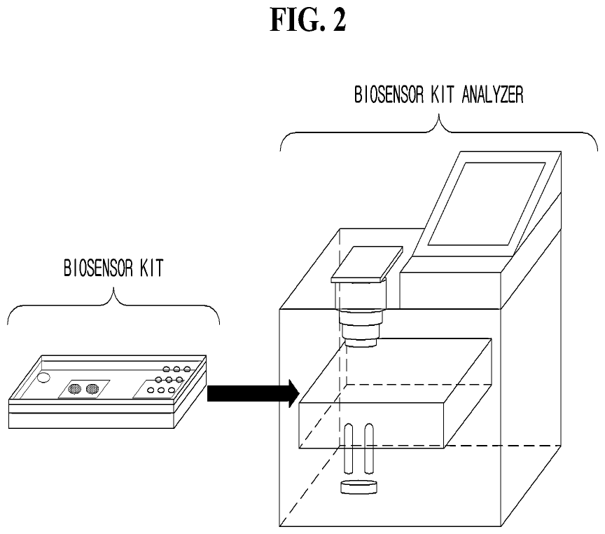

FIG. 2 is a configuration diagram of a bio system according to an embodiment of the present disclosure.

As shown in FIG. 2, the biosensor system may be composed of a biosensor kit including a biosensor and a biosensor analyzer. The biosensor kit in FIG. 2 shows a case where each structure is all combined.

The biosensor kit injected with the solution sample may be inserted into the biosensor kit analysis. The biosensor kit analyzer may inject incident light into the lower part of the metasurface element of the biosensor mounted in the biosensor kit. The biosensor kit analyzer may measure the pattern of output light changed by the meta surface element.

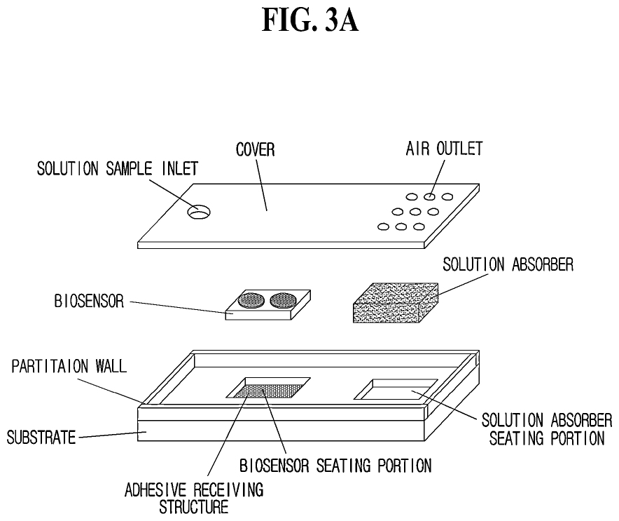

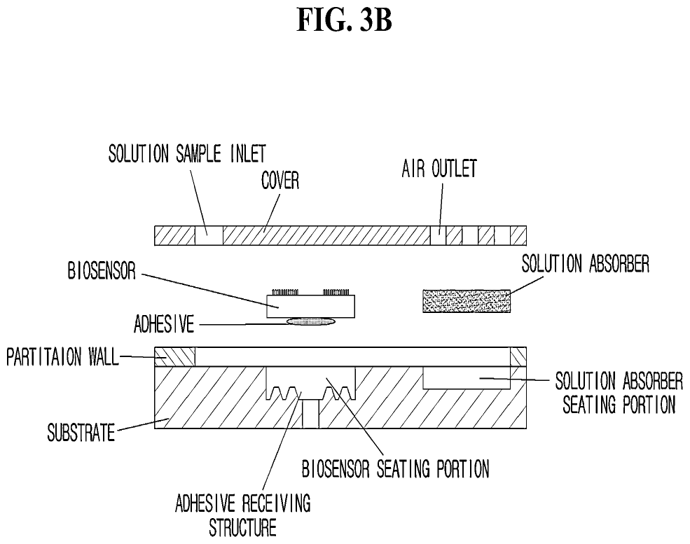

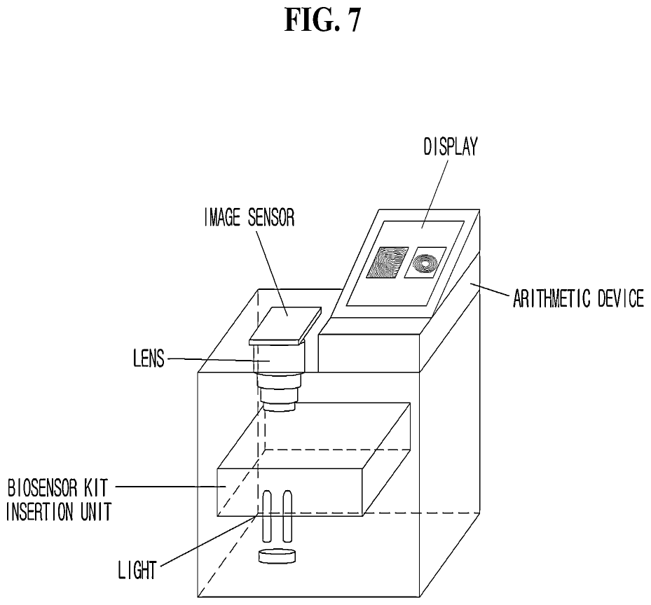

The configuration of the biosensor kit will be described in detail with reference to FIG. 3A to FIG. 6C and FIG. 9A to FIG. 10B. The configuration of the biosensor kit analyzer will be described in detail with reference to FIG. 7. The various configurations of the entire biosensor system will be described in detail with reference to FIG. 11 and FIG. 12.

FIG. 3A is a three-dimensional conceptual diagram of the biosensor kit, and FIG. 3B is a cross-sectional view of the biosensor kit. The material of one or more structures provided in the biosensor kit may be made of an optically transparent material.

Referring to FIG. 3A and FIG. 3B, the biosensor kit may be composed of a cover, a biosensor, a solution absorber, and a substrate.

The cover may be formed with a solution sample inlet and an air outlet. That is, when the cover is combined with the partition wall and/or the substrate, a solution sample may be injected through the solution sample inlet. Additionally, when the cover is coupled to the partition wall and/or the substrate, air within the biosensor kit may be injected or discharged through the air outlet.

A partition wall, an adhesive receiving structure, a biosensor seating portion, and a solution absorber seating portion may be formed on the substrate.

As shown in FIG. 3(b), when the biosensor is seated on the biosensor seating portion, the adhesive receiving structure may ensure that the adhesive prepared on the bottom of the biosensor is evenly distributed on the bottom of the biosensor without flowing back into the biosensor. At this time, the adhesive may be UV epoxy, but is not limited thereto.

When a solution is injected into the solution sample inlet, the solution absorber may prevent the solution from flowing back by absorbing the injected solution that has passed through the biosensor. The solution absorber may be seated on the solution absorber seating portion.

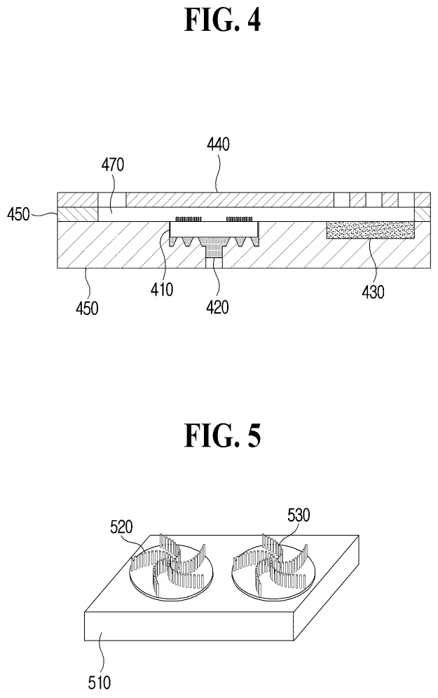

FIG. 4 shows a cross-sectional view of the biosensor kit after it is assembled, according to one embodiment of the present disclosure. The biosensor 410 is seated on the biosensor seating portion, and the adhesive 420 is distributed in the adhesive receiving structure to fix the biosensor 410. And, the solution absorber 430 may be seated on the solution absorber seating portion.

The cover 440 is attached to the top of the partition 460 formed on the substrate 450, and an empty space called a microfluidic channel 470 may be created between the substrate 450 and the cover 440. The width and length of the microfluidic channel 470 may be designed differently depending on the size of the biosensor 410.

FIG. 5 is a detailed view of a biosensor according to an embodiment of the present disclosure.

As shown in FIG. 5, the biosensor may be composed of a substrate 510 (i.e., the same as the substrate 450 in FIG. 4), a first meta-surface element 520, and a second meta-surface element 530.

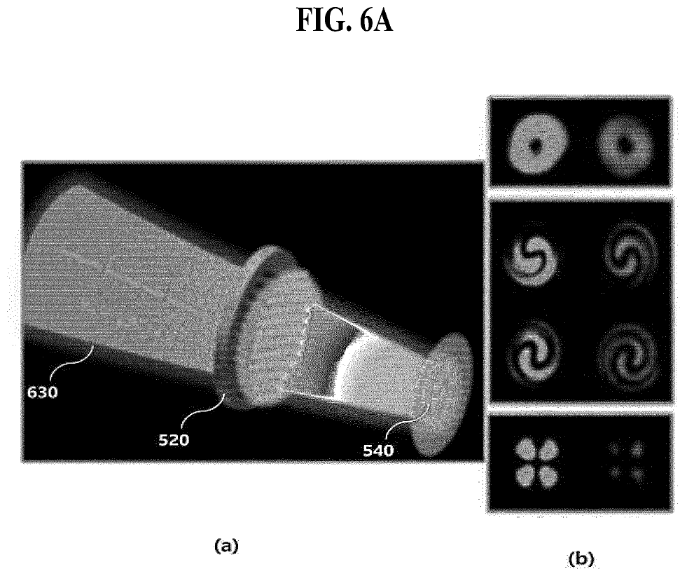

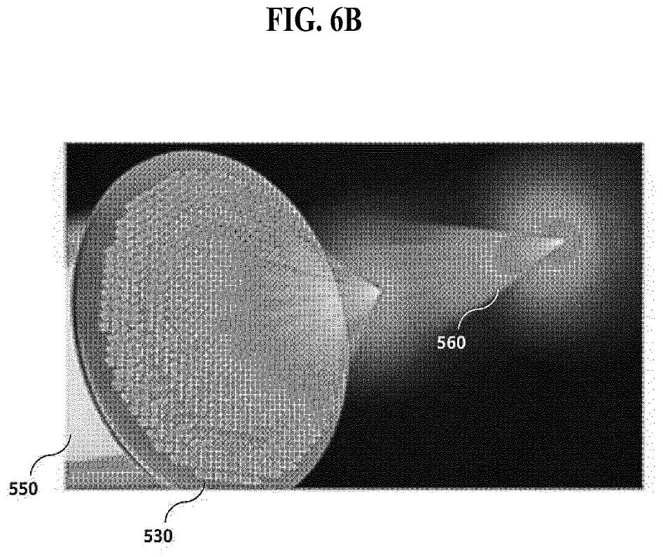

As an example, the first metasurface element 520 may be composed of a metasurface element capable of forming a structured beam. For example, as shown in (a) of FIG. 6A, incident light 530 from a light source may be injected into the lower end of the first meta surface element 520. At this time, as shown in (b) of FIG. 6A, the pattern of the output light 540 (or the cross section of the output light 540) may be structured in a donut shape, etc.

That is, the first meta surface element 520 may be composed of an element capable of generating a focused vortex beam.

The second meta surface element 530 may be composed of a meta lens element that focuses incident light on one point. For example, as shown in FIG. 6B, incident light 550 from a light source may be injected into the lower part of the second meta surface element 530, and thus output light 550 may be concentrated at one point.

FIG. 5 shows a case where the biosensor includes a first meta surface element 520 and a second meta surface element 530, but is not limited thereto. As an example, a first meta surface element 520 or a second meta surface element 530 may be provided on the biosensor. As another example, two or more metasurface elements may be provided on the biosensor. As another example, the type of metasurface element on the biosensor may also vary.

FIG. 7 is a detailed view of a biosensor kit analyzer according to an embodiment of the present disclosure.

As shown in FIG. 7, the biosensor kit analyzer may include a biosensor kit insertion unit, a light source, a lens, an image sensor, an arithmetic device, and a display.

Here, the computing device refers to a device (i.e., computer) that may control one or more components included in the biosensor kit analyzer and perform calculations. In other words, the computing device may control various functions of the entire biosensor kit analyzer in addition to image processing. A computing device may include one or more processors and/or one or more memory.

One or more processors may control the operation and functions of the light source, lens, image sensor, and display that make up the biosensor kit analyzer.

When the biosensor kit is inserted into the biosensor kit insertion part, the light source may inject incident light into the lower part of the metasurface element mounted on the biosensor kit.

The lens and image sensor may measure and/or photograph the pattern of output light changed by the meta surface element mounted on the biosensor kit. The output light pattern measured and/or captured by the lens and image sensor may be transmitted to a computing device.

Specifically, the lens and image sensor may be configured as one camera device (i.e., a photographing device). The camera device may photograph a pattern of output light changed by the meta surface element (that is, output light changed as incident light passes through the meta surface element) and transmit it to the computing device.

The output light pattern by the meta surface element measured/photographed by the lens and image sensor may be analyzed through an artificial intelligence (AI) model built into the computing device. In other words, the computing device may obtain the analysis result of the output light by inputting the output light pattern into the AI model. The analysis result of the output light may include the presence or absence and amount of biomaterial.

The presence or absence and amount of biomaterial obtained by the AI model may be displayed on the display. Specifically, the computing device may control the display to display the output light pattern and/or the presence or absence and amount of biomaterial corresponding to the output light pattern.

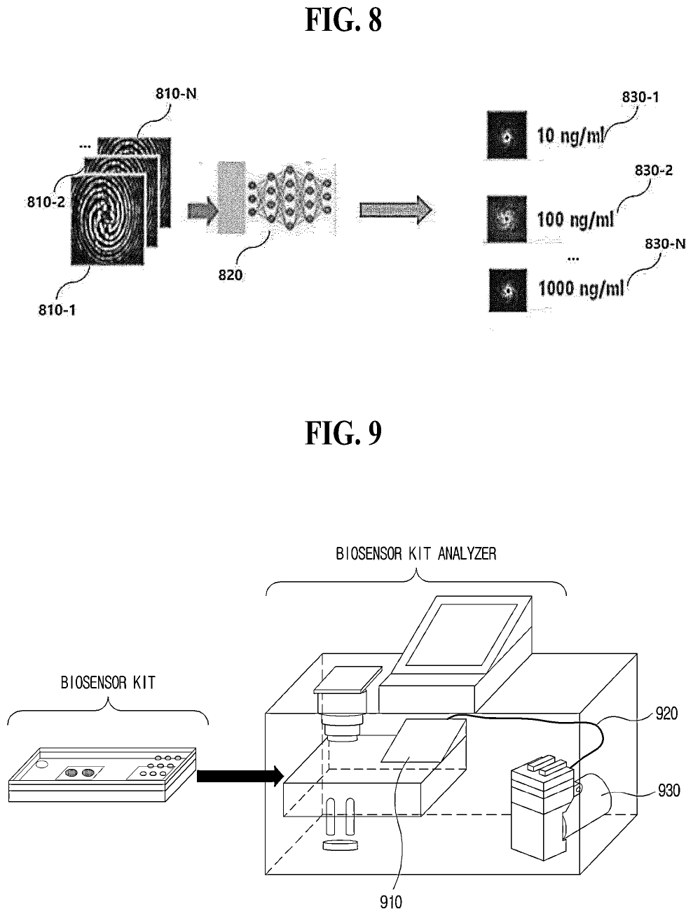

FIG. 8 is a conceptual diagram of an AI model learned to analyze an output light pattern, according to an embodiment of the present disclosure.

The AI model may be learned to output the presence or absence and amount of biomaterials based on the pattern of output light from the input metasurface device.

Here, the AI model may be composed of a convolutional neural network (CNN). A CNN may be composed of a combination of one or more convolutional layers and a pooling layer. Weights and/or biases set in one or more convolutional layers and pooling layers may be updated to output the presence or absence and amount of biomaterials.

The AI model may be learned based on the pattern image dataset of output light and the presence or absence and amount of biomaterials labeled in the image dataset. In other words, the AI model may be learned using a supervised learning method, but is not limited to this.

As shown in FIG. 8, one or more output light images (810-1, 810-2, . . . 810-N (N is a natural number of 1 or more)) captured by the metasurface element may be input to the AI model 820 by a computing device. The AI model 820 may output the presence or absence of biomaterials and the amount (830-1, 830-2, . . . 830-N) based on the input output light image 810.

As an example, based on the first output light image 810-1 being input, the AI model 820 may output the amount of biomaterials corresponding to the first output light image 810-1 (i.e., 10 ng/ml) (830-1). As another example, based on the Nth output light image 810-N being input, the AI model 820 may output the amount of biomaterials corresponding to the Nth output light image 810-N (i.e. 1000 ng/ml) (830-N).

FIG. 9 shows a biosensor system, according to another embodiment of the present disclosure.

The biosensor kit analyzer constituting the biosensor system may additionally include an air intake structure 910, a vacuum pump hose 920, and a vacuum pump 930 on the biosensor kit analyzer shown in FIG. 7. One or more processors included in the computing unit of the biosensor kit analyzer may control the operation and function of the vacuum pump.

The air intake structure 910 may be in contact with the air outlet of the biosensor kit. The air intake structure 910 may induce a (very weak) vacuum state into the microfluidic channel of the biosensor kit through the vacuum pump hose 920 by the operation of the vacuum pump 930.

The biosensor kit analyzer may measure and/or photograph the pattern of output light changed by the metasurface element mounted on the biosensor kit through a lens and an image sensor. The biosensor kit analyzer may obtain the presence or absence of biomaterials and their abundance by inputting images representing patterns of measured/photographed output light into an AI model. Since the operation of the biosensor kit analyzer has been described with reference to FIG. 7, redundant description will be omitted.

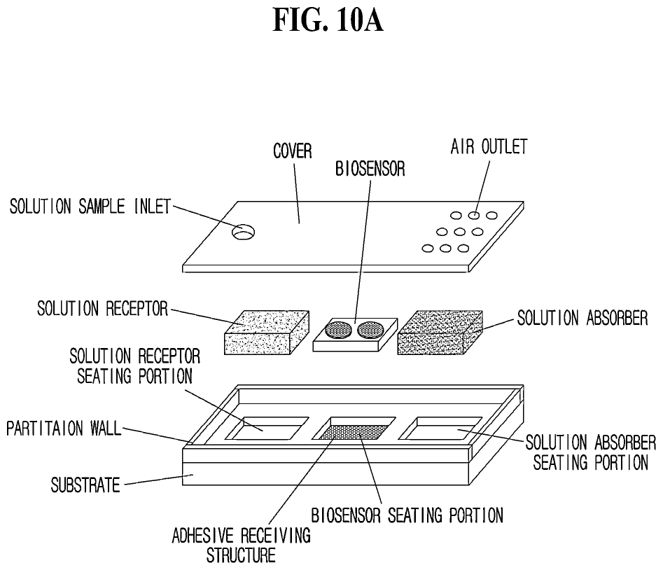

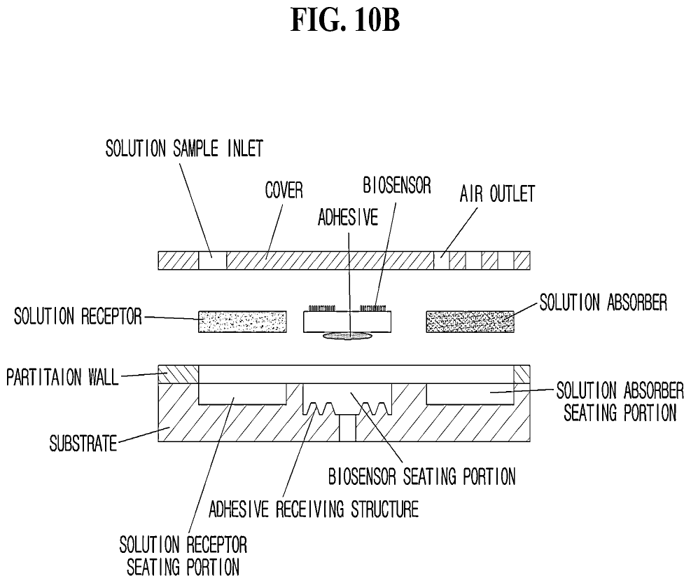

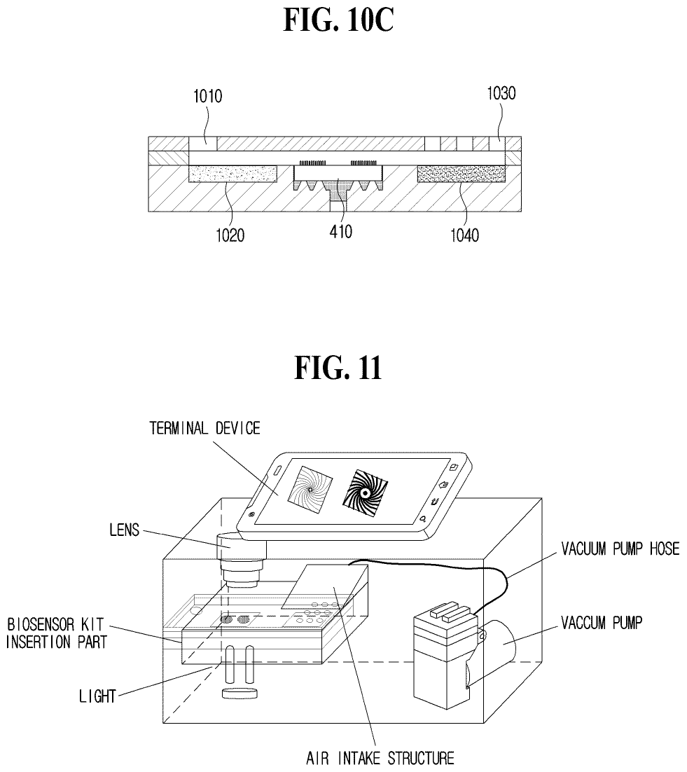

Additionally or alternatively, the biosensor kit constituting the biosensor system may additionally include a solution receptor and a solution receptor seating portion on the biosensor kit described with reference to FIGS. 2 to 4. A biosensor kit additionally including a solution receptor and a solution receptor seating portion will be described with reference to FIGS. 10A to 10C.

According to an embodiment of the present disclosure, FIG. 10A is a three-dimensional conceptual diagram of a biosensor kit, FIG. 10B is a cross-sectional view of the biosensor kit, and FIG. 10C is a cross-sectional view of the biosensor kit after assembly is completed.

As shown in FIGS. 10A and 10B, the solution receptor is located at the lower end of the solution sample injection port and may be seated on the solution receptor seating portion. The solution receptor may serve as a sample solution reservoir that absorbs the sample solution injected through the solution sample inlet and flows it to the biosensor.

Referring to FIG. 10C, part of the sample solution injected through the solution sample inlet 1010 may be absorbed into the solution receptor 1020, and the remaining part may flow to the biosensor 410. The air outlet 1030 may be connected to the air intake structure of the biosensor kit analyzer, and the air intake structure may be connected to the vacuum pump hose.

A vacuum state may be induced in the micro oil channel of the biosensor kit (i.e., inside the biosensor kit) through the vacuum pump hose by the operation of the vacuum pump. Accordingly, the sample solution absorbed in the solution receptor 1020 may be induced to flow into the microfluidic channel, react with the biosensor 410, and then be absorbed into the solution absorber 1040.

FIG. 11 shows a biosensor system, according to another embodiment of the present disclosure.

As shown in FIG. 11, the biosensor kit analyzer constituting the biosensor may be composed of a biosensor kit insertion part, a light source, a lens, an image sensor terminal device, an air intake structure, a vacuum pump hose, and a vacuum pump.

That is, in the case of the biosensor kit analyzer shown in FIG. 11, a terminal device (e.g., smartphone, tablet PC, etc.) can be used instead of the arithmetic device, display, and camera of the biosensor kit analyzer shown in FIG. 9. At this time, the terminal device may include a camera, display, and processor.

The image magnified through the lens of the biosensor kit analyzer (i.e., the output light pattern image by the metasurface element) may be measured by a camera built into the terminal device. The terminal device may store images captured by a camera, and the stored images may be analyzed by a processor built into the terminal device. For example, the terminal device may input the corresponding image stored by the processor into the AI model to obtain the presence or absence and amount of biomaterial based on the image.

Additionally or alternatively, the terminal device may transmit the stored corresponding image to a server in which the AI model is embedded through one or more communication modules (e.g., a wireless communication module and/or a wired communication module, etc.). The server may input the corresponding image received from the terminal device into the AI model and obtain the presence or absence and amount of biomaterial based on the image. The terminal device may receive the presence or absence and amount of biomaterial based on the corresponding image from the server.

The terminal device may display the presence or absence and amount of biomaterials obtained through the AI model through the display.

Components described in the exemplary embodiments of the present disclosure may be implemented by hardware elements. For example, the hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in the exemplary embodiments may be implemented as a combination of hardware and software.

The method according to an embodiment of the present disclosure may be implemented as a program that can be executed by a computer, and the computer program may be recorded in various recording media such as magnetic storage media, optical reading media, and digital storage media.

Various techniques described in this disclosure may be implemented as digital electronic circuits or computer hardware, firmware, software, or combinations thereof. The above techniques may be implemented as a computer program product, that is, a computer program or computer program tangibly embodied in an information medium (e.g., machine-readable storage devices (e.g., computer-readable media) or data processing devices), a computer program implemented as a signal processed by a data processing device or propagated to operate a data processing device (e.g., a programmable processor, computer or multiple computers).

Computer program(s) may be written in any form of programming language, including compiled or interpreted languages. It may be distributed in any form, including stand-alone programs or modules, components, subroutines, or other units suitable for use in a computing environment. A computer program may be executed by a single computer or by a plurality of computers distributed at one or several sites and interconnected by a communication network.

Examples of information medium suitable for embodying computer program instructions and data may include semiconductor memory devices (e.g., magnetic media such as hard disks, floppy disks, and magnetic tapes), optical media such as compact disk read-only memory (CD-ROM), digital video disks (DVD), etc., magneto-optical media such as floptical disks, and ROM (Read Only Memory), RAM (Random Access Memory), flash memory, EPROM (Erasable Programmable ROM), EEPROM (Electrically Erasable Programmable ROM) and other known computer readable media. The processor and memory may be complemented or integrated by special purpose logic circuitry.

A processor may execute an operating system (OS) and one or more software applications running on the OS. The processor device may also access, store, manipulate, process and generate data in response to software execution. For simplicity, the processor device is described in the singular number, but those skilled in the art may understand that the processor device may include a plurality of processing elements and/or various types of processing elements. For example, a processor device may include a plurality of processors or a processor and a controller. Also, different processing structures may be configured, such as parallel processors. In addition, a computer-readable medium means any medium that can be accessed by a computer, and may include both a computer storage medium and a transmission medium.

Although this disclosure includes detailed descriptions of various detailed implementation examples, it should be understood that the details describe features of specific exemplary embodiments, and are not intended to limit the scope of the invention or claims proposed in this disclosure.

Features individually described in exemplary embodiments in this disclosure may be implemented by a single exemplary embodiment. Conversely, various features that are described for a single exemplary embodiment in this disclosure may also be implemented by a combination or appropriate sub-combination of multiple exemplary embodiments. Further, in this disclosure, the features may operate in particular combinations, and may be described as if initially the combination were claimed. In some cases, one or more features may be excluded from a claimed combination, or a claimed combination may be modified in a sub-combination or modification of a sub-combination.

Similarly, although operations are described in a particular order in a drawing, it should not be understood that it is necessary to perform the operations in a particular order or order, or that all operations are required to be performed in order to obtain a desired result. Multitasking and parallel processing can be useful in certain cases. In addition, it should not be understood that various device components must be separated in all exemplary embodiments of the embodiments, and the above-described program components and devices may be packaged into a single software product or multiple software products.

Exemplary embodiments disclosed herein are illustrative only and are not intended to limit the scope of the disclosure. Those skilled in the art will recognize that various modifications may be made to the exemplary embodiments without departing from the spirit and scope of the claims and their equivalents.

Accordingly, it is intended that this disclosure include all other substitutions, modifications and variations falling within the scope of the following claims.

What is claimed is:

1. A Method performed by a biosystem comprising a biosensor kit and a biosensor kit analyzer, the method comprising:
injecting a solution sample into the biosensor kit through the solution sample inlet, the biosensor kit including a biosensor equipped with at least one metasurface element;
based on the biosensor kit being inserted into the biosensor kit analyzer, injecting incident light into a lower region of the at least one metasurface element by the biosensor kit analyzer;
obtaining a pattern image of output light changed by the at least one meta-surface element using the biosensor kit analyzer;
obtaining, by the biosensor kit analyzer, a presence or absence and amount of biomaterial on the solution sample by inputting the pattern image into a pre-trained artificial intelligence model; and
displaying the presence or absence and amount of the biomaterial on the solution sample by the biosensor kit analyzer.

2. The method of claim 1, wherein:
the at least one meta surface element include at least one of a first meta surface element and a second meta surface element,
the first meta surface element includes a meta surface element that converts the incident light into a structured beam, and
the second meta surface element includes a meta lens element that focuses the incident light to a specific point.

3. The method of claim 1, wherein:
the structured beam includes a focused vortex beam.

4. The method of claim 1, wherein:
the biosensor kit includes a biosensor seating portion on which the biosensor can be seated and an adhesive receiving structure capable of accommodating the adhesive added to the lower area of the biosensor.

5. The method of claim 1, wherein:
the biosensor kit absorbs the solution sample injected through the solution sample inlet and includes a solution receptor, and
a fluid channel through which the solution sample can flow is formed between a cover of the biosensor kit and the solution receptor.

6. The method of claim 5, wherein:
the biosensor kit includes an air outlet that absorbs or discharges air from the outside, and
the biosensor kit analyzer includes an air intake structure connected to the air outlet, a vacuum pump hose connected to the air intake structure, and a vacuum pump connected to the vacuum pump hose.

7. The method of claim 6, wherein:
the biosensor is located in an area corresponding to a direction of the air intake structure with respect to the solution receptor within the biosensor kit, and
based on the biosensor kit being inserted into the biosensor kit analyzer, air on the fluid channel is discharged outside the biosensor kit through the air intake structure and the vacuum pump hose by the vacuum pump.

8. The method of claim 7, wherein:
the biosensor kit includes a solution absorber that absorbs the solution sample that has passed through the biosensor, and
the solution absorber is located in an area corresponding to a direction of the air intake structure with respect to the biosensor within the biosensor kit.

9. A bio-system comprising:
a biosensor kit comprising a biosensor equipped with at least one metasurface element; and
a biosensor kit analyzer including at least one processor, light source, lens, image sensor, and display,
based on a solution sample being injected through a solution sample inlet on the biosensor kit, the biosensor kit is inserted into the biosensor kit analyzer, and
the at least one processor is configured to:
inject incident light through the light source into a lower region of the at least one metasurface element;
obtain a pattern image of output light changed by the at least one meta surface element through the lens and the image sensor;
obtain, by the biosensor kit analyzer, a presence or absence and amount of biomaterial on the solution sample by inputting the pattern image into a pre-trained artificial intelligence model; and
display the presence or absence and amount of the biomaterial on the solution sample on the display using the biosensor kit analyzer.

10. The bio-system of claim 9, wherein:
the at least one meta surface element include at least one of a first meta surface element and a second meta surface element,
the first meta surface element includes a meta surface element that converts the incident light into a structured beam, and
the second meta surface element includes a meta lens element that focuses the incident light to a specific point.

11. The bio-system of claim 10, wherein:
the structured beam includes a focused vortex beam.

12. The bio-system of claim 9, wherein:
the biosensor kit includes a biosensor seating portion on which the biosensor can be seated and an adhesive receiving structure capable of accommodating the adhesive added to the lower area of the biosensor.

13. The bio-system of claim 9, wherein:
the biosensor kit absorbs the solution sample injected through the solution sample inlet and includes a solution receptor, and
a fluid channel through which the solution sample can flow is formed between a cover of the biosensor kit and the solution receptor.

14. The bio-system of claim 13, wherein:
the biosensor kit includes an air outlet that absorbs or discharges air from the outside, and
the biosensor kit analyzer includes an air intake structure connected to the air outlet, a vacuum pump hose connected to the air intake structure, and a vacuum pump connected to the vacuum pump hose.

15. The bio-system of claim 14, wherein:
the biosensor is located in an area corresponding to a direction of the air intake structure with respect to the solution receptor within the biosensor kit, and
based on the biosensor kit being inserted into the biosensor kit analyzer, air on the fluid channel is discharged outside the biosensor kit through the air intake structure and the vacuum pump hose by the vacuum pump.

16. The bio-system of claim 15, wherein:
the biosensor kit includes a solution absorber that absorbs the solution sample that has passed through the biosensor, and
the solution absorber is located in an area corresponding to a direction of the air intake structure with respect to the biosensor within the biosensor kit.

17. A method performed by a bio system including a biosensor kit, a biosensor kit analyzer, and a terminal device mounted on the biosensor kit analyzer, the method comprising:
injecting a solution sample into the biosensor kit through the solution sample inlet, the biosensor kit including a biosensor equipped with at least one metasurface element,
based on the biosensor kit being inserted into the biosensor kit analyzer, injecting incident light into a lower region of the at least one metasurface element by the biosensor kit analyzer;
obtaining a pattern image of output light changed by the at least one meta-surface element using the biosensor kit analyzer;
obtaining, by the biosensor kit analyzer, a presence or absence and amount of biomaterial on the solution sample by inputting the pattern image into a pre-trained artificial intelligence model; and
displaying the presence or absence and amount of the biomaterial on the solution sample by the biosensor kit analyzer.

18. The method of claim 16, wherein:
the pattern image is transmitted by the terminal device to a server including at least one parameter for executing the artificial intelligence model, and
the presence or absence and amount of biomaterial on the solution sample based on the pattern image are transmitted from the server to the terminal device.
